(19) United States
(12) Patent Application Publication
(10) Pub. No.: US 2008/0206453 A1
(43) Pub. Date: Aug. 28, 2008

(54) Method for Decorating an Article and Equipment Therefor

(76) Inventor: Jean-Noel Claveau, Coisia (FR)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/792,978

(22) PCT Filed: Dec. 13, 2005
(86) PCT No.: PCT/FR05/03115

§ 371 Date: Jul. 17, 2007

(30) Foreign Application Priority Data
Dec. 15, 2004 (FR) 04/52990

(51) Int. Cl. B41M 5/035; B65D 88/74

(52) U.S. Cl. 427/148; 220/592.28

(57) ABSTRACT

A process for decorating an article, including preparing a transfer sheet of flexible paper by printing with at least one subliming substance; applying the transfer sheet to the article to be decorated; and applying heat by dipping the article to be decorated and the transfer sheet into a bath of non-ferrous metal alloy maintained at a nominal temperature to activate the subliming substance.

### RELATED APPLICATION

This is a §371 of International Application No. PCT/FR2005/003115, with an international filing date of Dec. 13, 2005 (WO 2006/064120 A1, published Jun. 22, 2006), which is based on French Patent Application No. 04/52990, filed Dec. 15, 2004.

### TECHNICAL FIELD

This disclosure relates to the decoration of articles by transferring thermoactivable substances such as thermoactivable inks, especially subliming inks or also gilding substances.

### BACKGROUND

The general principle of transference is known, such as described in my earlier patents.

EP 0 451 067 discloses a process for the decoration of the surface of an object by transferring a decoration with the aid of a machine comprising two frames articulated to one another of which one of the faces is integral with an elastically deformable membrane to form a tight enclosure, of the type consisting:
in arranging at least one object of any shape on the support sheet in contact with the decoration;
in covering the object with another support sheet in such a manner that its decorated face is in contact with this object;
in hermetically closing the enclosure, characterized in that it consists:
   in adhering an isolating layer on the face of each support sheet opposite its decoration;
   in placing the support sheet in such a manner that its decorated face is directed outward;
   in arranging at least one object on the support sheet and more particularly on the decoration to be transferred;
   in covering the object with a second support sheet in such a manner that its decorated face is in contact with this object;
   in introducing the unit consisting of the support sheet and the object into a hermetic enclosure;
   in placing the enclosure in a partial vacuum; and
   in introducing the enclosure into an oven regulated at a determined temperature in order that the decorated faces of the support sheets penetrate by sublimation into the mass of the object.

EP 0 606 189 discloses a machine for subliming a decoration on objects with any shape, of the type comprising two frames articulated to one another and of which one of their faces is integral with an elastically deformable membrane, characterized in that at least one of the deformable membranes comprises preformed pockets suitable for completely receiving each of these objects to be decorated.

EP 0 544 603 discloses a process for decorating the surface of an object by sublimation with ink, characterized in that it consists:
in using as a support of subliming ink a material that is sufficiently extensible and permeable to air in order to be able to adapt to the shape of the object to be decorated without risk of deterioration of the decoration to be sublimated;
in enveloping the object in the ink support in order that all its faces are covered; and
in placing the unit into a known machine under a vacuum that is itself introduced into a hot space in order to bring about the transfer of the decoration on all the faces of the object to be decorated.

EP 1 099 569 discloses a process for applying a decoration on an article comprising the steps consisting in: arranging a support covered with a subliming ink in contact with a face of the article; heating the support with the aid of heating means to bring about the sublimation of the ink and its transfer onto the article while cooling the opposite face of the article with the aid of cooling means.

WO 99/62722 discloses a process permitting the application of a decoration onto the surface of an object using printing with subliming ink. In that process a thermoretractable film provided with a subliming ink decoration is used as ink support or as transfer sheet. In another process permitting application of a decoration on the surface of an object by means of printing with subliming ink, an ink support or a classic transfer sheet as well as an overwrapping of thermoretractable film is used. The sheet of film can be provided with joints in such a manner as to form an envelope and a subliming ink decoration can be present, if required, on the inner surface of the envelope. The object to be decorated is arranged inside the film envelope. If a classic transfer sheet is used, it is arranged on the object before the thermoretractable film is overwrapped. Before proceeding to the printing with subliming ink the object can be pretreated with a covering on which the decoration will be printed. The film envelope is heated in such a manner that the film retracts in order to adapt to the surface of the object. The retraction of the film around the object, when it is combined with the heat, produces the pressure necessary to transfer the decoration of the film to the surface or to the covering of the object to be decorated. Once the transfer by sublimation has been achieved, the film can be maintained in place as an overwrapping or it can be withdrawn just like the classic transfer sheet that was possibly used, thus uncovering the newly decorated object.

The solutions of the prior art are not totally satisfactory because they require numerous and delicate manipulations to realize a precise transfer, in particular, when the article that is to receive the transfer is fragile or has complex shapes. The heat necessary for the sublimation of the ink imposes rather long heating times, resulting in heating the article to be decorated. This is not advantageous for articles that are fragile or made of temperature-sensitive materials.

### SUMMARY

I provide a process for decorating an article, including preparing a transfer sheet of flexible paper by printing with at least one subliming substance; applying the transfer sheet to the article to be decorated; and applying heat by dipping the article to be decorated and the transfer sheet into a bath of non-ferrous metal alloy maintained at a nominal temperature to activate the subliming substance.

I also provide equipment including a thermostated vat containing a bath of non-ferrous metal alloy for carrying out the process for decorating an article.

### DETAILED DESCRIPTION

I provide a process for the decoration of an article comprising a step for the preparation of a transfer sheet by printing with at least one thermoactivable ink, a transfer step by application of this sheet onto the article to be decorated and by heating this unit, characterized in that the heating is performed by dipping the article to be decorated associated with the transfer sheet into a bath of non-ferrous metal alloy maintained at a nominal temperature for the activation of the thermoactivable ink, and in that this sheet is a sheet of flexible paper.

The term “flexible paper” denotes a sheet of paper which is not stiff and is very bulky, that is, it has a low specific mass. Such papers are used in particular in the sanitary and domestic areas for the manufacture of disposable handkerchiefs, absorbent paper, toilet paper or hygienic paper.

The processes for manufacturing flexible sheets of paper are well known and described in numerous patents. For example, FR 2 708 453 describes such a process.

The sheet of paper is advantageously made of cotton-wool-like cellulose. Cotton-wool-like cellulose is the paper most frequently used in the sanitary and domestic area, especially for the manufacture of disposable handkerchiefs. The gsm substance is very low.

The sheet of paper is advantageously a sheet of the type used to manufacture disposable handkerchiefs.

Other types of transfer film have been envisaged: a film of TEFLON, a sheet of transfer paper used for the decoration of fabric by sublimation, a film of siliconized paper, an adhesive, an elastomer, a natural latex, a synthetic latex or a flock sheet of natural polyisoprene. The flocks are constituted of cotton fibers, viscose fibers, polyamide fibers, acrylic fibers or polyester fibers.

However, the flexible sheet of paper as defined above has the advantage at the same time of being quite inexpensive and being able to perfectly match the contours of the article to be decorated.

According to a first aspect, the bath is formed by an alloy based on antimony, tin, bismuth and lead. According to a second aspect, the bath is formed by an alloy based on bismuth, lead, tin, cadmium. According to a third aspect, the bath is formed by an alloy of non-ferrous metals comprising bismuth.

According to a preferred aspect, the thermoactivable ink is a subliming ink. According to another aspect, the thermoactivable ink is an ink of the “thermomeltable” type.

Heating for activation of the ink during the transfer step is preferably ensured by a bath of an alloy composed of bismuth, lead, tin and cadmium (Bi 50%, Pb 25%, Sn 12.5%, Cd 12.5%) whose melting point is approximately 70° C., maintained at a temperature of approximately 190° C.

I also provide equipment for carrying out the process, characterized in that it comprises a thermostated vat containing a bath of an alloy of non-ferrous metals.

My processes and equipment will be better understood from the description of the following non-limiting examples for implementation.

The transfer sheet for carrying out the process is advantageously constituted of a sheet of paper of cotton-wool-like cellulose, e.g., a sheet of cotton-wool-like cellulose of the type used to manufacture disposable handkerchiefs. The sheet is printed with a subliming ink by a classic process of image transfer printing such as photogravure, serigraphy or simply printing by an ink jet printer.

The image, numbered and processed by a computer, is printed with a special subliming ink on a professional ink jet printer or any ad hoc printing equipment.

Subliming inks are generally constituted of molecules of modest sizes and masses with a compromise between the existence of double conjugated bonds and conjugated cycles permitting the molecules to be colored and the decrease of the molecular masses so that the molecules are compatible with the sublimation.

It is also possible to use inks with a change of phase and more particularly thermomelting inks for printing the transfer sheet.

The printed transfer sheet is then applied on the article to be decorated.

There is then a heating to a temperature and a compatible time that are required for the transfer of the thermoactivable ink.

In the absence of indications supplied by the distributor of the thermoactivable ink, one skilled in the art knows how to determine the optimal conditions by simple routine trials. For this, a first temperature and time, e.g., 180° C. for 2 seconds, is selected and then incremented by regular steps, e.g., by steps of 5° C. and by steps of 0.5 seconds until achieving a level in the quality of the transfer.

The heating can be ensured by a flow of hot air or a bath in a hot liquid.

The unit formed by the transfer sheet and the article to be decorated is advantageously plunged into a path of nonferrous metal alloy with a low melting point. This is, e.g., an alloy composed of bismuth, lead, tin and cadmium (Bi 50%, Pb 25%, Sn 12.5%, Cd 12.5%) whose melting point is approximately 70° C., maintained at a temperature of approximately 190° C.

The process can also be used for decorating a wire, e.g., of a cable or an electrical wire. In this case, the wire can make contact with the transfer sheet realized in the shape of a band. The wire passes between a system of rollers located upstream and downstream from the bath.

The transfer sheet also passes on a system of rollers situated upstream and downstream from the bath. The wire and the transfer band make contact upstream from the bath to plunge together into the heating bath in which a rollers located that ensures the guiding inside of this bath.

The transfer is made inside the bath and the decorated wire exits from the bath, where it is recovered on a bobbin.

1-12. (canceled)

13. A process for decorating an article, comprising:
preparing a transfer sheet of flexible paper by printing with at least one subliming substance;
applying the transfer sheet to the article to be decorated; and
applying heat by dipping the article to be decorated and the transfer sheet into a bath of non-ferrous metal alloy maintained at a nominal temperature to activate the subliming substance.

14. The process according to claim 13, wherein the sheet of paper is cotton-wool-like cellulose.

15. The process according to claim 13, wherein the sheet of paper has a gsm substance lower than 20 g/m².

16. The process according to claim 13, wherein the sheet of paper is a sheet of the type used for manufacturing disposable handkerchiefs.

17. The process according to claim 13, wherein the bath is formed by an alloy based on antimony, tin, bismuth and lead.

18. The process according to claim 13, wherein the bath is formed by an alloy based on bismuth, lead, tin and cadium.

19. The process according to claim 13, wherein the bath is formed by an alloy of non-ferrous metals comprising bismuth.

20. The process according to claim 13, wherein the subliming substance is a subliming ink.

21. The process according to claim 13, wherein the subliming substance is a gilding substance.

22. The process according to claim 13, wherein heating to activate the ink during transfer is assisted by a bath of an alloy composed of bismuth, lead, tin and cadmium whose melting point is approximately 70° C. and maintained at a temperature of approximately 190° C.

23. The process according to claim 22, wherein the bath contains 50% Bi, 25% Pb, 12.5% Sn and 12.5% Cd.

24. The process according to claim 13, further comprising a passing step of the transfer sheet in the form of a band, and placing the transfer sheet in contact with a wire to be decorated upstream from the bath.

25. Equipment comprising a thermostated vat containing a bath of non-ferrous metal alloy for carrying out the process according to claim 1.
